(19) United States
(12) Patent Application Publication
(10) Pub. No.: US 2022/0237704 A1
(43) Pub. Date: Jul. 28, 2022

(54) METHOD AND SYSTEM FOR DETERMINING BENEFIT

(71) Applicant: Greenpast Limited, Bromley (GB)

(72) Inventor: Antonios Camille Zamar, Bromley (GB)

(73) Assignee: Greenpast Limited, Bromley (GB)

(21) Appl. No.: 17/583,630

(22) Filed: Jan. 25, 2022

Related U.S. Application Data
(60) Provisional application No. 63/140,982, filed on Jan. 25, 2021.
(60) Provisional application No. 63/282,165, filed on Nov. 22, 2021.

(51) Int. Cl. G06Q 40/08

(52) U.S. Cl. CPC G06Q 40/08

(57) ABSTRACT

A method and system for determining the benefit of an insurance policy of an insured entity, the policy associated with a term of employment of a worker of the insured entity. The method comprises: retrieving data indicative of: a disclosure event characteristic of a disclosure made by the worker, an indication that the disclosure event is in a public interest, and a trigger event; comparing the data indicative of the disclosure event and the data indicative of the trigger event; determining, based at least in part on the comparing, a link between the trigger and disclosure events; determining that a predetermined time has not been exceeded; determining, based on the data of the disclosure event and the data of the trigger event, a benefit for the insurance policy; and transmitting an indication of the benefit for the policy. The aim is a solution that prevents whistleblower victimisation, fostering protection for workers making disclosures of workplace wrongdoing.

### CROSS-REFERENCE TO RELATED APPLICATIONS

This application claims priority from and is related to U.S. Provisional Application No. 63/282,165, filed Nov. 22, 2021, and U.S. Provisional Application No. 63/140,982, filed Jan. 25, 2021, each of these aforementioned patent applications are hereby incorporated into the present application by reference in its entirety.

### FIELD OF THE INVENTION

The present invention relates to a method and system for processing an insurance claim and establishing a benefit from an insurance policy, such as triggering an insurance payout.

### BACKGROUND TO THE INVENTION

Whistleblowing is increasingly prevalent and is proving to play an important role in the healthy functioning of society. The role of the whistleblower in bringing to light any issue in the public interest, mainly since it is workers who most commonly are first in highlighting wrongdoing within their employer organisations.

There remain, however, several hurdles preventing workers whistleblowing, including principally a fear of reproach or victimisation from the organisation, or from one or more individuals within such an organisation, as a response to the whistleblowing. Such victimisation can arise from any level within an organisational hierarchy, from peers to management, and can act as a primary barrier to whistleblowing.

Protection against such victimisation is scarce, and where present, often lacks consideration for the long-term maintenance of an employment culture where whistleblowing can play an important role in sustaining the health of businesses.

Current solutions often only allow for relief against victimisation to be sought upon the availability of evidence of such victimisation, as well as the availability of funds to litigate, which can make it difficult to obtain a fair and effective long-term relief for a whistleblower. This merely acts to deter and suppress future whistleblowing, once colleagues become aware of the risks of victimisation for speaking out.

Additionally, many solutions involve a financial incentive, which carries a variety of drawbacks, not least since such solutions risk encouraging malicious reporting, and has previously prompted employees to entrap others into insubordinate or corrupt behaviour in order to collect a reward, or to merely speculate through claims of wrongdoing, in the hope of some reward. In some cases therefore, the recipient of such a reward could themselves be a perpetrator.

Direct financial incentives to workers additionally serves to damage the credibility of such individuals during an internal investigation, calling their motives into question—not least for the above reasons.

Such prior solutions therefore undermine the introduction and maintenance by employers of a safe and effective culture of internal whistleblowing, which should be encouraged simply as good workers' practice. It should be standard practice to raise such issues because such disclosures are not only in the public interest but also in the interest of the employer, not because there may be some reward to gain from doing so.

It is therefore desirable to provide a solution which prevents whistleblower victimisation before it occurs, and preferably which fosters a healthy, robust and long-term infrastructure of protection for employees making well-intentioned disclosures of wrongdoing within the workplace.

### SUMMARY OF THE INVENTION

The present invention is directed to a method and system for implementing an insurance policy for an insured entity, and particularly for determining benefit to a beneficiary of such a policy following victimisation for whistleblowing. In particular the present invention is directed to a method of determining a benefit of an insurance policy based on a trigger event, which may be the registering of a grievance, a suspension or a termination of a worker (or any other form of victimisation), following a disclosure made by the worker. The method and system preferably also comprises determining a link between the disclosure and the trigger event, wherein the link may be that the same worker having made the disclosure is the worker associated with the trigger event. Additionally, the method and system preferably also comprises determining whether the disclosure is in the public interest, which may be an indication made by the worker, or made following a review of the disclosure by a party independent to the insured entity, or more preferably following a review of the disclosure by the insured entity. Such a method and system preferably leads to an infrastructure which discourages employee or worker victimisation as a result of a disclosure. The present invention therefore preferably provides a long-term stable commitment on behalf of an insured entity to protect its workers against victimisation, such as that resulting from a disclosure in the public interest, or in the interest of the insured entity.

Typical forms of whistleblowing protection share inherent drawbacks in that they can be manipulated or otherwise abused by the parties involved. Additionally these typical forms of protection can rely on the presence of evidence of victimisation. The present method by contrast seeks to provide an opportunity for commitment on behalf of an insured entity to a robust and fair review, and subsequent determination and issuance of a benefit, following any such victimisation before it takes place.

Therefore, in accordance with a first aspect of the present invention, there is provided a method for determining a benefit for an insurance policy of an insured entity, the policy associated with a worker of the insured entity, the method comprising: retrieving data indicative of: (i) a disclosure event characteristic of a disclosure made by a worker of the insured entity; (ii) an indication that the disclosure event is in the interest of a public; and (iii) a trigger event; comparing the data indicative of the disclosure event and the data indicative of the trigger event; determining, based at least in part on a result of the comparing, a link between the trigger event and the disclosure event; determining that a predetermined time threshold has not been exceeded; determining, based on the data indicative of the disclosure event and the data indicative of the trigger event, a benefit for the insurance policy; and transmitting an indication of the benefit for the insurance policy.

The determining of a benefit is preferably performed in accordance with regional laws, and therefore the predetermined time threshold may be determined according to the laws. The present invention preferably seeks to protect workers against victimisation and preferably protects against lost income, material, social, psychological and health damages, and/or legal fees via the covering legal costs of litigation (for example, in the seeking of damages from the courts). The transmitting of the indication of the benefit, and indeed the benefit itself, is preferably sourced from the insured entity performing the victimisation, thereby preferably ensuring that any offending organization meets the cost of the policy aiming to protect itself and its workers. The offending organisation is preferably therefore penalised if the policy is activated, and if the disclosure was a bona fide disclosure, for example in the interest of a public. The present method will therefore preferably render any insured organisation more sensitive and aware of the need to protect workers, and would preferably lessen victimisation of workers, since insurance premiums may preferably increase punitively is such an occurrence takes place. Further proposed advantages of the present invention preferably include a protection of worker income early and before the worker suffers the victimisation by way of the trigger event; providing an early stage legal opinion to both organisation and worker in the best interest of the organisation and worker; lessening the risk of victimisation of workers; saving insured organisations significant resources, for example fines, punitive damages and criminal proceedings, by allowing the organisation to detect any wrongdoing at very early stages; and encouraging an insured organisation to be more sensitive to workers raising concerns, thereby preferably reducing a risk of victimisation as the offending organisation may suffer punitive premium rises in cost if it is demanded to be in branch of whistleblowing laws

In accordance with a second aspect of the present invention, there is provided a system for determining a benefit for an insurance policy of an insured entity, the policy associated with a worker of the insured entity, the system comprising: a computer memory for storing data indicative of: (i) a disclosure event characteristic of a disclosure made by a worker of the insured entity; (ii) an indication that the disclosure event is in the interest of a public; and (iii) a trigger event; and a processor in communication with the memory, wherein the processor is configured to: determine the presence of a the indication; compare the data indicative of the disclosure event and the data indicative of the trigger event; determine, based at least in part on a result of the comparing, a link between the trigger event and the disclosure event; determine that a predetermined time threshold has not been exceeded; determine, based on the data indicative of the disclosure event and the data indicative of the trigger event, a benefit for the insurance policy; and transmit an indication of the benefit for the insurance policy.

The system is preferably arranged to perform a method in accordance with the first aspect, and may be maintained and/or owned by the insured entity and/or an insurer of the insured entity. In any embodiments wherein the system is maintained and/or owned by the insurer of the insured entity, any the data is received from the insured entity by the system. In any embodiments wherein the system is owned by the insured entity, the worker can trigger the insurer's involvement on the platform if detriment is perceived to have occurred. The platform preferably informs the worker of the deadline for any claim of detriment to be made according to local legislation.

In accordance with a third aspect, there is provided a non-transitory, computer readable medium having stored thereon instructions that, upon execution, cause a computing device (which may be comprised within a system of the second aspect) to perform a method in accordance with the first aspect.

The worker is preferably one selected from a group of a part-time or full-time worker or employee of the insured entity; a contractor of the ensured entity; a self-employed affiliate of the insured entity; a registered student of the insured entity. The insured entity may be any suitable governmental or non-governmental entity, including any suitable private or governmental institution, and may be a company or an academic institution such as a university. Examples may include universities, academies, private and public registered companies, military, police, hospitals and any other emergency services providers, among others which will be appreciated.

The disclosure event preferably comprises data associated with the insured entity. In particular embodiments, the disclosure event may comprise data associated with wrongdoing or aberrant departure from normal procedures harming, or potentially harming, public interest or other individuals by or within the insured entity.

The data indicative of the disclosure event preferably comprises identification data linked to the worker. The identification data may in some embodiments, be encrypted or anonymised. In such embodiments, the comparing of the data indicative of the disclosure event and the data indicative of the trigger event may comprise a decryption of the encrypted identification data of the worker. The worker preferably initially brings up a the concern for example, embezzlement of funds or unsafe or dishonest practice by or within the insured entity (for example, the worker's employer), on the platform confidentially to the insured entity (e.g., the employer). The employer should investigate the concern, and if no cause for concern is found, this is registered. If the concern is found to be valid, then remedial action should be taken. If the worker is victimised as a result of raising a concern, preferably at that point, and only at that point is the insurer invited in the platform. This preferably gives the employer a chance to remedy the situation prior to any claim being filed. Failure to remedy the situation would result in a claim (and any associated insurance benefit or payout) being triggered.

The trigger event may preferably be one selected from a group of a registered grievance received from the worker; a registered suspension of employment and/or contract and/or registration status of the worker; a registered maltreatment or discriminatory treatment recorded by the worker; a registered termination of employment and/or contract and/or registration status of the worker or indeed treating the worker in any disadvantageous or discriminatory way which may harm livelihood or the health and/or the wellbeing of the worker following disclosure; or a result of a review concluding that the worker was not victimised. In embodiments wherein the trigger event is, or comprises, the result of a review concluding that the worker was not victimised, the method preferably ceases. The review may be performed most preferably by, or within, the insured entity or any suitable body associated therewith, or alternatively by any suitable body independent of the insured entity. The data indicative of the trigger event preferably comprises a recorded or stored data indicating the trigger event, and may, for example, comprise one or more selected from: a date of the trigger event and/or a date of the recording or storage; a time of the trigger event and/or a time of the recording or storage; information indicative of a type of the trigger event; identification data linked to the worker. The data indicative of the trigger event may, in some embodiments, include data indirectly indicative of the trigger event, such as evidence implicative of the trigger event. Such evidence may, for example, include a detected period of absence, such as an extended period of absence which may be calculated to be atypical for the worker (for example greater than a rolling average of weekly/monthly/quarterly/biannual/annual absence taken by the worker), preferably wherein the period of absence is recorded as stress-related absence. In some preferable embodiments, the identification data may be encrypted and/or anonym ised.

The worker may have access to a “suggestions box”, a “concerns raising point”, a data entry point of a software application or any other suitable forum for whistleblowing within an insured entity as will be appreciated, through which to make a disclosure by, for example, raising an issue on the system, which may link to, for example, a database as a first point of identification to triggering an activation of the present method or policy.

The public may, for example, be one selected from a group of: the insured entity; a populous of a country or region, or a governing body of the country or region. As such the public may be any person or body about which the disclosure may relate or be of interest to the public and may include the general public.

The data indicative of an indication that the disclosure event is in the interest of the public may, in some embodiments, be retrieved from an entity separate from the insured entity. In some embodiments, the indication may be received and stored in the memory from an entity independent of the insured entity. The method may therefore include a step of transmitting the disclosure to a the separate entity and receiving from the separate entity the indication for storage, for example, on the memory. Following the transmitting, the separate entity may perform an independent review of the disclosure to determine whether the disclosure is in the public interest.

The comparing and/or the determining based at least in part on a result of the comparing, a link between the trigger event and the disclosure event preferably comprises: identifying that the data indicative of the disclosure and the data indicative of the trigger event comprise identification data associated with the worker; and/or an indication that the trigger event occurred subsequently to the disclosure event, which may be within a predetermined period of time since the disclosure event.

The predetermined time threshold may preferably be a legal or regulatory time period, limit or threshold imposed locally within a jurisdiction, and may depend on various states and federal jurisdictions, and may specifically relate to an interval between raising a concern and the application of a detriment to an associated worker. The predetermined time threshold may, therefore, be associated with a legal time period associated with one or more of: the disclosure; the trigger event; and any detriment which may be discriminatory and targeting the worker in a financial, social, psychological or physical manner. In some embodiments, the predetermined time threshold may be stored in, and accessible from the memory of the system, which may be for the purpose of determining that the predetermined time threshold has not been exceeded.

The benefit preferably comprises one or more selected from a group of financial cover for an injunction to halt discriminatory practice against the worker; reinstatement of a contract of the worker; compensatory relief for the worker; previous or future legal fees of the worker, which may be to litigate and defend the worker's rights associated with whistleblowing. The compensatory relief preferably comprises one or more selected from a group of lost income of the worker associated with the trigger event; damages associated with the trigger event; legal expenses; or any suitable financial cover which may, for example, cover any damages to the worker as a result of the trigger event/detriment. The benefit of the present invention is therefore preferably arranged to cover continued income from the employer (which is preferably the insured entity) via the triggering of injunction proceedings, losses, damages (whether material or immaterial), and legal fees for the worker associated with the trigger event, which may be any form of workplace victimisation including but not limited to suspension or termination of the employment term, contract or registration. Any the benefit or compensatory relief is preferably at least in part transmitted by/received from the insured entity (for example, a system of the insured entity, or an insurer of the insured entity, in accordance with the second aspect). In most preferred embodiments, any the benefit or compensatory relief is preferably wholly received from, and transmitted by, the insured entity (for example, a system of the insured entity, or an insurer of the insured entity, in accordance with the second aspect). Basically, the policy covers legal costs so that the worker can protect their livelihood whilst fighting a whistleblowing court case. Any damages are paid by the employer, not the insurer via the courts if the case against the employer is successful.

The benefit may preferably comprise one or more selected from a group of an increase in premium of the insurance policy of the insured entity. The benefit may, therefore, preferably include further punitive measures on the insured entity should the insurance policy be activated—such as by determining the benefit.

The insurance policy preferably comprises either an existing insurance policy or a potential insurance policy to be offered to the entity.

It will be appreciated that features described herein as being suitable for incorporation into one or more aspects and embodiments of the present invention are intended to be generalizable across any and all aspects and embodiments of the present disclosure.

### BRIEF DESCRIPTION OF THE DRAWINGS

Embodiments of the present invention will now be described by way of example only and with reference to the accompanying drawings, in which:

FIG. 1 shows a flow chart representing initial steps including those of an example embodiment of a method in accordance with a first aspect of the present invention, performable by a system in accordance with the second aspect running a non-transitory computer readable medium in accordance with the third aspect;

FIG. 2 shows a flow chart representing further steps of the method of FIG. 1;

FIG. 3 shows a block diagram of an example system in accordance with the second aspect arranged to run a non-transitory computer-readable medium in accordance with the third aspect;

FIG. 4 shows a diagram representing converting input in different file format or document format from users into a standardized format;

FIG. 5 through FIG. 8 are more detailed flows of FIG. 1 and FIG. 2; and

FIG. 9 through FIG. 25 are user interface example screens illustrating the progression through the flow diagrams of FIG. 5 through FIG. 8.

### DETAILED DESCRIPTION

As required, embodiments are disclosed herein; however, it is to be understood that the disclosed embodiments are merely examples and that the methods described below can be embodied in various forms. Therefore, specific structural and functional details disclosed herein are not to be interpreted as limiting but merely as a representative basis for teaching one skilled in the art to variously employ the present subject matter in virtually any appropriately detailed structure and function. Further, the terms and phrases used herein are not intended to be limiting, but rather, to provide an understandable description of the concepts.

The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

### Non-Limiting Definitions

The terminology used herein is for the purpose of describing particular embodiments only and is not intended to be limiting of the invention. As used herein, the singular forms “a”, “an” and “the” are intended to include the plural forms as well, unless the context clearly indicates otherwise.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

The term “client device” is any device, such as a computer, laptop, smartphone, tablet, television, or other information processing device in which web-browsers and apps can be processed.

The term “document format” in natural language processing is the process of identifying and categorizing the regions of interest in the scanned image of a text document. A reading system requires the segmentation of text zones from non-textual ones and the arrangement in their correct reading order.

The term “file format” is the structure of a file that tells a program how to display or access its contents. For example, file formats include Doc, DocX, TXT, Google Doc, HTML, PDF with renderable text i.e., editable, PDF without renderable text, which must be converted using text recognition, such as optical character recognition (OCR), techniques, and handwritten that must be converted to text using text recognition.

The term “policy” in the field of insurance is a contract between the insurer and the policyholder, which determines the claims which the insurer is legally required to pay. In exchange for an initial payment, known as the premium, the insurer promises to pay for loss caused by perils covered under the policy language. The policy can be purchased by the employer/organisation and the application for their staff/contractors to use. However in another embodiment, the staff/contractors may contribute to the payment of the policy or pay for the entire policy.

The term “worker” means employee, contractors and consultants to an employer/organisation, whether full or part-time, contractors and consultants.

### Overall System Flow

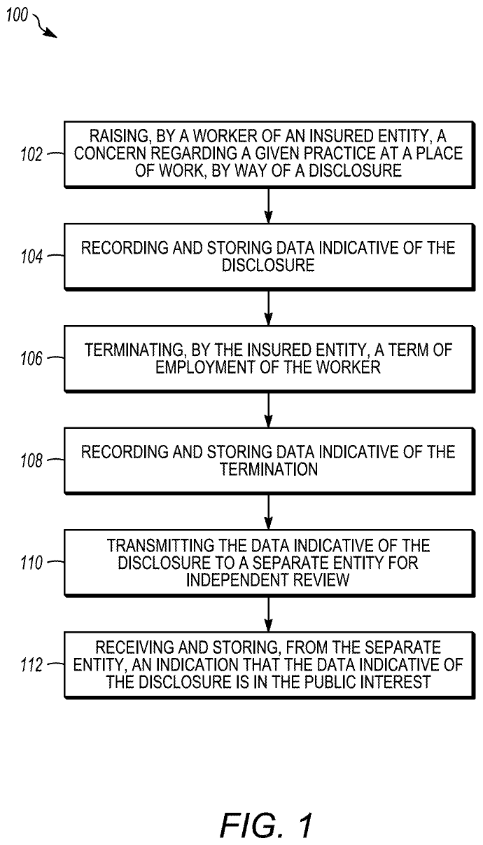

Referring to FIG. 1, a flow chart is provided showing steps of an example embodiment 100 of a method in accordance with the first aspect. The method 100 shown includes the steps of:

raising, by a worker of an insured entity, a concern regarding a given practice at a place of work, by way of a disclosure 102;

indicating, by the worker that the disclosure is in the public interest 104, and an explanation as to how so;

recording and storing data indicative of the disclosure and of the indication 106;

incurring a detriment by the insured entity, upon the worker 108; and

recording and storing data indicative of the detriment 110 (which may be psychological, financial, physical, or related to work status).

Following a recording and storing of the data indicative of the detriment, the insurance policy is preferably triggered, and in embodiments implemented using a software application, an insurance provider may have access to the software platform, which may include visibility of the data indicative of the disclosure, the indication and the detriment. Triggering of the policy may be performed by the worker, or in some embodiments may be performed by the insured entity. For example the recording of the disclosure and the indication may be followed by an internal review or investigation by the insured entity. Following the outcome of such a review, and in some embodiments following a trigger event, the insured entity may initiate the triggering of the policy. Such policy triggering preferably remains confidential until the matter may be litigated in court or brought to the attention of an external agency following the failure of an internal investigation.

In many cases, it is not possible for the insured entity to have a separate, independent entity investigate every disclosure made by a worker, and therefore such initial internal reviews by the insured entity may be useful. Demonstrating that an internal investigation has taken place and the outcome, if possible, is preferably sufficient to prevent triggering of the policy. If the internal investigation fails (by for example, finding that the disclosure is in the public interest and/or that a detriment has followed), then the worker is preferably able to raise the concern with an external body, such as a regulator or any suitable law enforcement body, which may in some embodiment be performed, or advised, by way of the software application.

Other embodiments will be appreciated wherein the raising of the concern 102 is in the public interest. Embodiments will be appreciated wherein the detriment 108 trigger event is any form of detriment to the worker, which may be recorded by the worker. The detriment 108 trigger event may instead be, or may be in addition to, an investigation, whether by or within the insured entity, or by a body independent of the insured entity, concluding that the worker was not victimised. In such embodiments, the method preferably ceases following the conclusion.

After a concern is raised by the worker 102 and an indication that the disclosure is in the public interest 104, the concern and the indication are logged and stored 106. At a time subsequent to the disclosure, the worker is victimised 108, in this example case by a termination of their employment contract with the insured entity, which is also logged and stored 110. In other embodiments, as a result of a concern being raised by the worker, data indicative of the disclosure may be transmitted to a third party independent to the insured entity for an independent review as to whether the disclosure of interest to the general public and indication of which is subsequently received and stored.

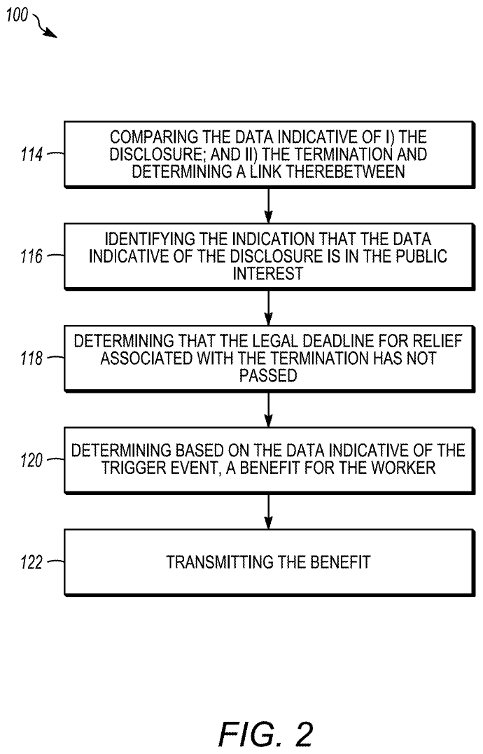

In any case, prior to, or during, proceeding to the next steps of the method, shown in FIG. 2, the method can be stopped (and the associated insurance claim/benefit determination) aborted if an indication is provided that the insured entity (i.e. the employer of the worker) or an associated or independent organisation is taking steps to investigate the concern raised by the worker, and to protect the worker from detriment.

The worker, the insured entity (which in this example is the employer of the worker), and the insurance provider associated with the policy all have access to and visibility of, any database where the workers may record concerns. In the example case, such access by the insurance provider is only available following a failed internal review by the insured entity or by the recording and storing of a detriment by the worker.

Referring to FIG. 2, a flow chart is provided showing further steps of the example embodiment 100. The further steps include:

comparing the data indicative of i) the disclosure; and ii) the detriment and determining a link therebetween 114;

identifying the indication that the data indicative of the disclosure is in the public interest 116;

determining that the legal deadline for relief associated with the detriment has not passed 118;

determining based on the data indicative of the detriment, a benefit for the worker 120; and

transmitting the, or an indication of the, benefit 122.

Upon receipt and storage of the indication that the disclosure is in the interests of the general public, the data indicative of the disclosure and the data indicative of the trigger event (in this example case, a termination) are compared 114, and a determination is made that a link exists between the data. In the particular example shown, the determination of the link involves an identification that one or more workers associated with the disclosure is the same as one or more workers associated with the trigger event. Other possible determinations may include that a predetermined time period has not yet passed, such that a reliable temporal link between the disclosure and the trigger event may be drawn. In the present embodiment identifying a the link, the trigger event occurs subsequent to the disclosure.

Following the determination of a link, and a subsequent identification 116 that the disclosure is in the public interest, a determination 118 is made that a legal deadline for submitting the claim by the worker has not yet passed.

Following a determination that the legal deadline has not yet passed, a benefit of the insurance policy is determined 120, which in the example embodiment shown comprises a determination of lost earnings of the worker based on a period since the trigger event (which in the example shown is a termination of the worker). Determining the benefit 120 in the example shown further comprises a determination of damages incurred to the worker following the trigger event, which may be performed on a case by case basis, and in some embodiments may be performed algorithmically based on one or more of: a type of the trigger event (for example, suspension, termination or any other form of workplace victimisation or detriment); a salary, role or level of seniority of the worker within the insured entity; a period of employment of the worker at the insured entity. Such damages may be material or immaterial and may, for example, be determined based on a level of inconvenience or harm perceived by the worker. Other benefits which may be determined may include legal costs incurred by the worker, for example, during any contesting of the trigger event. Such a determination may be performed based on data indicative of the legal costs, which may for example, be stored on a system of the second aspect.

Following the determination of the benefit 120, the benefit is transmitted to the worker, which in the present embodiment is performed by the insured entity. Embodiments will be appreciated wherein the benefit is transmitted to the worker by an insurer of the insured entity. The term “transmission to the worker” will be understood in the context of the present invention to refer to any suitable transmission, such as to a bank account of the worker.

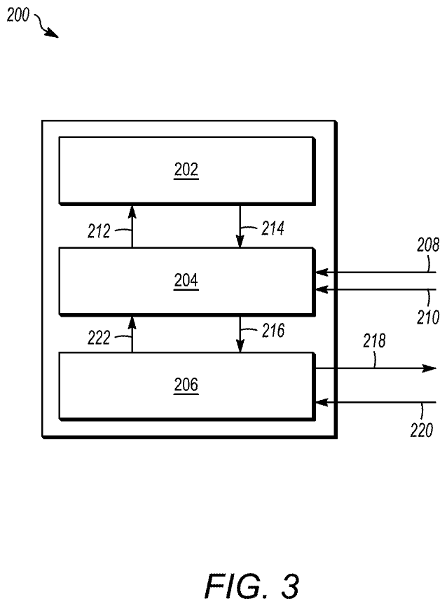

Referring to FIG. 3, an example system 200 is shown arranged to perform steps of the method 100 of FIG. 1 and FIG. 2. The system comprises a memory 202, a processor 204, and a transceiver 206. The processor 204 is arranged to access and process the data indicative of the disclosure 208 and the data indicative of the trigger event 210 and store 212 the data on the memory 202. The processor 204 is further arranged to access 214 the data indicative of the disclosure stored in the memory 202 and output 216 this data to the transceiver 206. The transceiver 206 is arranged to transmit 218 the data indicative of the disclosure to the independent third-party entity (not shown). Subsequent to an independent review of the data indicative of the disclosure by the independent third party entity, the transceiver 206 is further arranged to receive 220 the indication that the disclosure is in the interest of the general public. The processor 204 is arranged to receive and process 222 the indication and store 216 data indicative of the indication in the memory 202. The memory 202 of the embodiment shown additionally comprises, stored thereon, a predetermined time threshold for making an insurance claim following a detriment imposed on a worker subsequent to a disclosure. The system 200 is arranged to perform the steps of the method 100 shown in FIG. 2.

The manner of receiving the data in a method in accordance with the first aspect, for storage by a computer memory in a system according to the second aspect, may be by any suitable means. In some embodiments, the data indicative of the disclosure and/or the data indicative of the trigger event may be received from a remote device of the worker. For example, a software application may, in some embodiments, be implemented on remote devices of workers of the insured entity arranged to be interacted with by the workers for the purpose of logging concerns associated with the insured entity, which may be an employer of the worker. The software application may, in some embodiments, be a peripheral application to a central application or database, for example hosted on a central server of the system, and arranged to receive, store and process data from the remote devices. The remote devices may additionally include computing devices of the insured entity, which may be used to record personal data of the workers including employment records which may be a source of detected trigger events such as suspensions or terminations of the workers. The employment records may additionally be used by the system to determine or infer evidence of trigger events, such as extended periods of absence of a worker following a disclosure, which may include data indicative of stress-related absence. Such evidence may be stored on the system of the second aspect as the data indicative of the trigger event, and received as part of the method of the first aspect.

Interaction by a worker with a software application of the remote device preferably includes the logging of the disclosure, and may further include the logging of a trigger event, such as a report of victimisation submitted by the worker. The logging may result in the storing of the disclosure and/or trigger event data on the remote device for processing as part of the method of the first aspect, and/or transmission of the data by the remote device to a system of the second aspect for storage on a memory of the system, for subsequent processing. Alternatively, or additionally, the system may receive data indicative of the trigger event, or data indicative of an alternative or additional trigger event, by way of an external system or logging procedure.

The data indicative of an indication that the disclosure is of interest to a public may be obtained as described herein, and following review by the insured entity or by a third party, and may be stored on a memory of the system.

The memory of the system may have stored thereon a predetermined time threshold associated with a legal time limit for making a claim against worker victimisation in a local jurisdiction.

The processor of the system is then arranged to perform the steps of the method 100 shown in FIG. 2.

For example, a software application implementing, or used to implement, the present method may require a worker and an insured entity to register on the application prior to accessing features of the application. Such a registration procedure may for example, be a stipulation of an insurance policy of the insured entity. The application may, for example, permit workers to register a concern by way of a disclosure in a data entry point of the software application. The application may additionally accept interaction from the worker indicating that the disclosure is in the public interest and/or the worker's interest. The insured entity may have access to data indicative of the disclosure and/or the indication that the disclosure is in the public interest by way of a separate insured entity login for the application. The data visible to the insured entity may anonymize the worker. The insured entity may then investigate the concern or disclosure raised, which may occur within a predetermined time threshold, such as the normal time limit to investigate issues within the organization. The software application may receive data or evidence indicative of the progress of the investigation by the insured entity, and may set out a step-by-step investigative procedure to be followed by the insured entity. If the worker feels victimised as a result of making the disclosure within a predetermined time threshold, such as the duration allowed in a given jurisdiction, they may register this on the application and an insurance provider (who may in some optional embodiments own or maintain the application, otherwise owned by the insured entity and maintained by a third party or the insured entity) may then have visibility of the application data in full sight of the insured entity. Such a system then favours a review performed by the insured entity, which may in some optional embodiments involve the insurance provider and/or an independent third party, with a view to averting an insurance claim being submitted by the worker. If this step fails to remove the recorded detriment to the worker, then the insurance policy is preferably triggered, an injunction may be applied to stop the detriment (whether financial or otherwise as will be appreciated) and a full claim may ensue in court with legal costs of the worker covered as part of the insurance policy.

Further embodiments within the scope of the present invention may be envisaged that have not been described above. For example, in the embodiments shown, the method includes the step of receiving data indicative of the detriment from the worker or an indication that an insurance claim has been made by the worker. Other embodiments will be appreciated wherein the determination of benefit is performed automatically upon a determination that the disclosure and the trigger event are linked following the respective comparison.

In optional embodiments, the method may include the step of transmitting the data indicative of the disclosure to an entity independent of the insured entity (for independent third party review) following the receipt of the indication that an insurance claim has been made by the worker (or other registering of a detriment or grievance by the worker). Embodiments will be appreciated wherein the data indicative of the disclosure is automatically submitted to the independent entity following retrieval or processing of the data by the processor, and/or following retrieval and processing of the data indicative of the trigger event, and/or following the determining that the disclosure and the trigger event are linked following the respective comparison. Embodiments like those described will also be appreciated wherein the data indicative of the disclosure is not submitted to a separate entity and instead reviewed internally by the insured entity. In such embodiments, following the internal review, the processor is arranged to receive and store data indicative of an indication that the disclosure in the interest of a public in accordance with that described herein. In embodiments wherein the review is performed internally within the insured entity, the review is preferably performed by a body unaffiliated or otherwise independent of the worker or the worker's role within the insured entity.

In the embodiment shown, the trigger event is a termination of an employment contract of the worker with the insured entity. The trigger event may, in other embodiments, be any suitable form of workplace victimisation.

### Converting File Formats and Document Formats Into A Standard Format

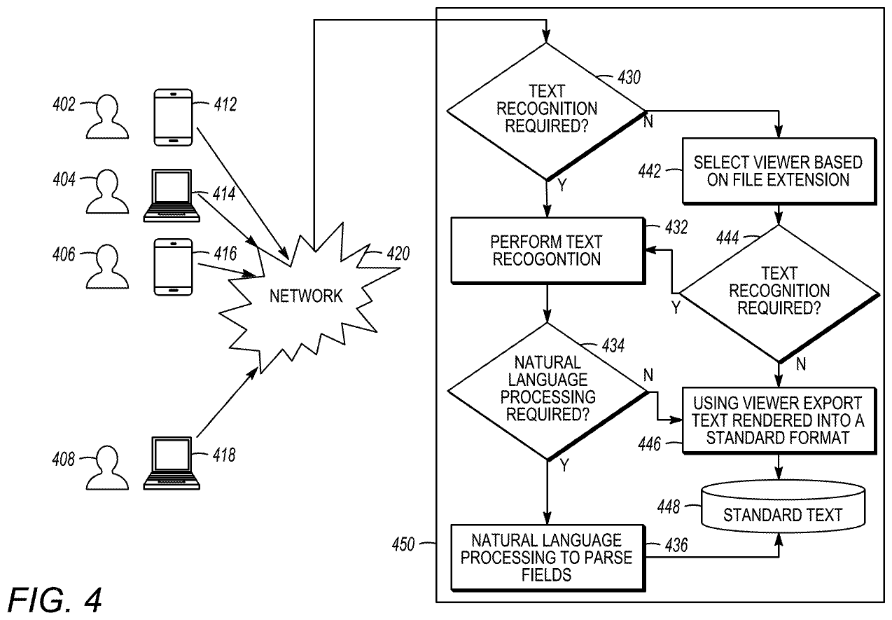

FIG. 4 shows a diagram representing converting input in different file formats or document formats from users into a standardized format. Shown are user devices 412, 414, 416, and 418, with users 402, 404, 406, and 408. In this example, each of the user devices receives user input in a different file format, a different document format, or both. These different file formats may be due to the different user devices, e.g., Android versus iOS versus Windows. Or they may be the result of user preferences, e.g., user 402 prefers Google Docs, where user 404 prefers MS Word, and user 406 prefers straight text. Each of the user devices sends their input over a network 420, such as internet 420, to system 450. The input in one example is a file.

In one example, each of the user devices 412, 414, 416, and 418 are able to receive input from each respective user 402, 404, 406, and 408 offline and store the input locally. Only when the devices are back on wireless network 420, such as Wi-Fi or cellular, does the data from each of the user devices 412, 414, 416, and 418 automatically transfer to system 450. This data can be data related to a concern for a given practice at the place of work or data indicative of an employee termination, data indicative of the disclosure is in the public interest, or a combination thereof.

Upon receiving the data, a test is made if text recognition is required in step 430. The test in one example is looking at the filename extension or file type creator codes. In the event the filename extension or file type creator is available, the process continues to step 442. In step 442, a corresponding application is selected to render the file contents and continues to step 444. If the data opens without errors in step 444 the text can be recognized, i.e., renderable, for example, in a PDF or Word document, and the process continues to step 446. Otherwise, in the event of an error, the process flows to step 432, as shown.

In step 446, the viewer is used to export the renderable text into a standard format which is stored in step 448.

In the case text recognition is required in step 430, the process flows into step 432. Text recognition is performed in step 432. The text is typically part of an image that is typed or handwritten. After text recognition is performed, the process continues to step 434. In step 434, a test is made to determine if natural language processing (NLP) should be used to improve text recognition and to extract data from different document formats. In the event NLP is required, the process continues to step 436. Otherwise, if NLP is not required, the text from the recognition is stored in database 448. In step 436 natural language processing is performed. One example of natural language processing is BERT from Google and solutions from Innodata and SaS.

Once the data is received at system 450, the data received is examined to determine if text recognition is required 430. Then, the process continues to step 448, in which the results of the text recognition and NLP are stored.

### Detailed Flow Diagrams

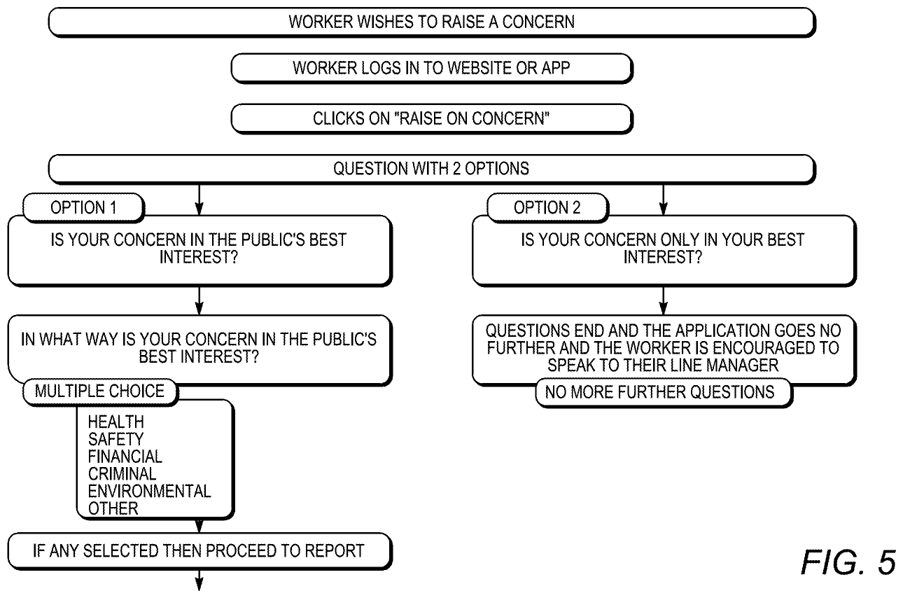

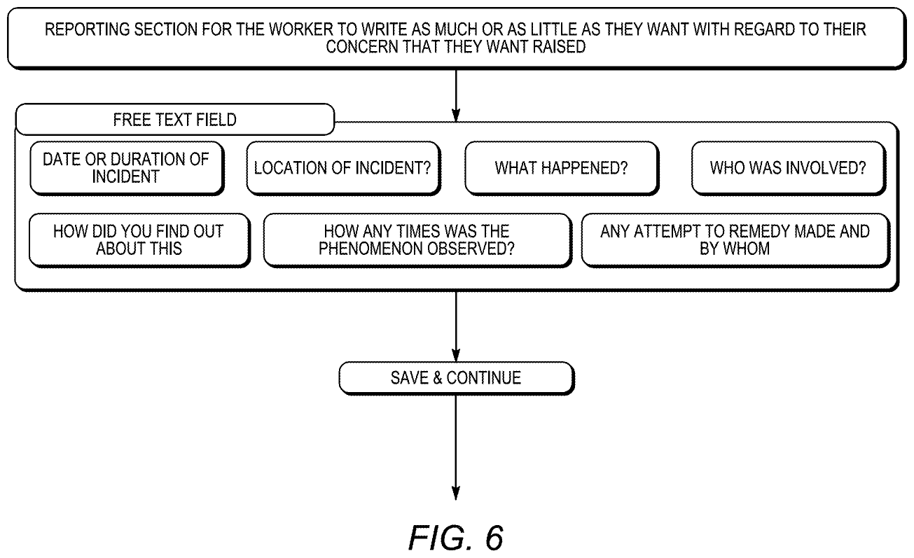

FIG. 5 through FIG. 8 are more detailed flows of FIG. 1 and FIG. 2. All communications and data may be encrypted for extra security. Or the data encrypted when being stored. More specifically, turning to FIG. 5, illustrates a worker that wishes to raise a concern. The worker logs in to a website or uses the App and selects “Raise a Concern.” The user is presented a question on whether this concern is in the “public's best interest” or only “your best interest.” In the event the user selects that the concern is only in the employee's best interest, the process ends. Otherwise, if the concern is in the public's best interest, the process continues, and the user is presented with multiple choices for the category of the interest. Example categories include “Health”, “Safety”, “Financial”, “Criminal”, “Environmental”, and other. After selecting a category, the process flows to FIG. 6.

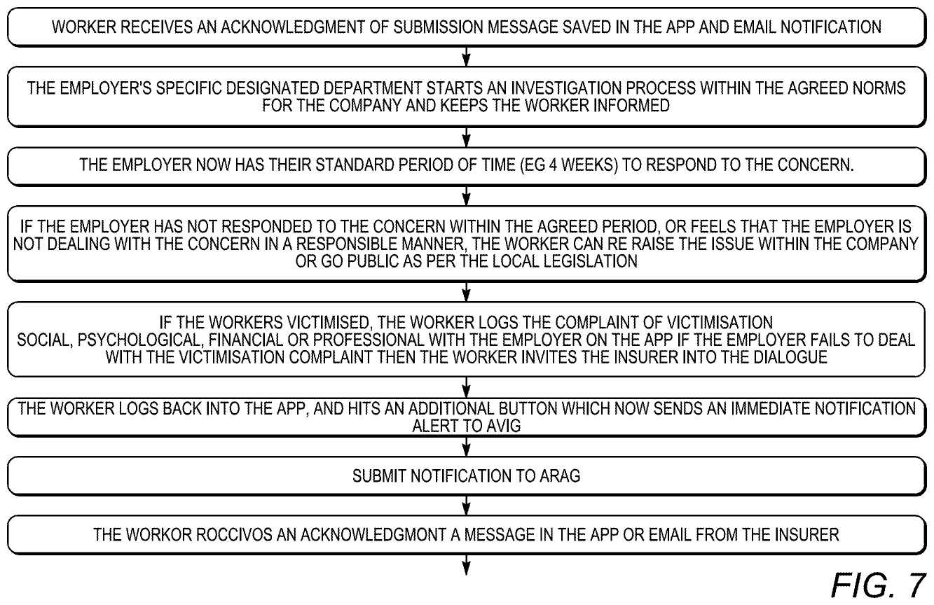

Turning now to FIG. 6, the worker is presented with fields to fill-in, such as date, location, what happened, who was involved, how this concern became known to the worker, how many times the concern was observed, and any attempt to remedy. Some of these fields are pull-downs, and others are free text. Or in one example, as detailed in FIG. 4, various unique document formats and document types are uploaded. The process continues to FIG. 7.

Referring to FIG. 7 the worker receives an acknowledgement of the submission of FIG. 6. Next, the designee of the employer starts the investigation. Typically, the investigation must be completed within a given time period. In the event the employer does not respond to the concern or the employee feels that the employer is not dealing with the concern in a responsible manner, the employee can raise the issue within the company or go public as per the local legislation.

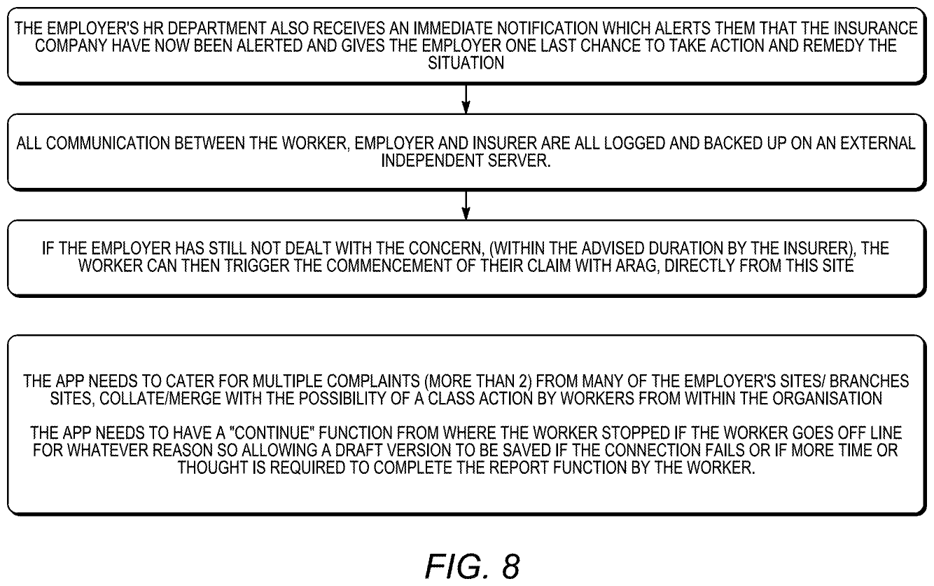

In the event the worker is victimized, the worker logs the complaint of victimisation (social, psychological, financial, or professional with the employer on the App.) If the employer fails to deal with the victimization complaint, then the worker invites the insure into the dialogue. The worker notifies “legal protection insurance,” e.g., ARAG via the App or website. The worker receives an acknowledgment from ARAG. The process continues to FIG. 8.

In FIG. 8 the employer's humane resource (HR) department also received an immediate notification which alerts them that the insurance company have now been alerted. In one example, all the communication and data, besides being encrypted is also backed up on an external independent server. Lastly, in the event the employer has not dealt with the concern (within the advised duration of the insured), the worker can then trigger the commencement of their own claim with the legal protection insurance.

In one example, the system enables multiple complaints (more than 2) from many of the employer's sites/branches sites, collate/merge with the possibility of a class action by workers from within the organization. The App includes a “continue” function from where the worker stopped if the worker goes offline for whatever reason so allowing a draft version to be saved if the connection fails or if more time or thought is required to complete the report function by the worker

### User Interface Progression

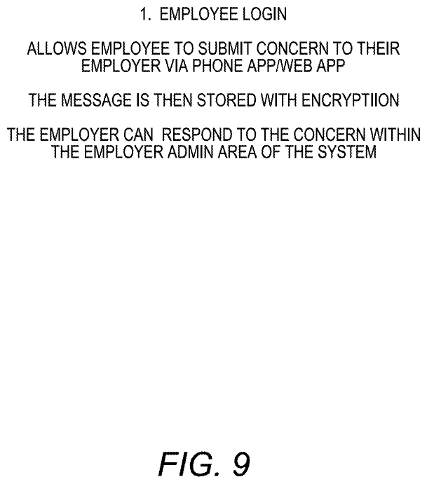

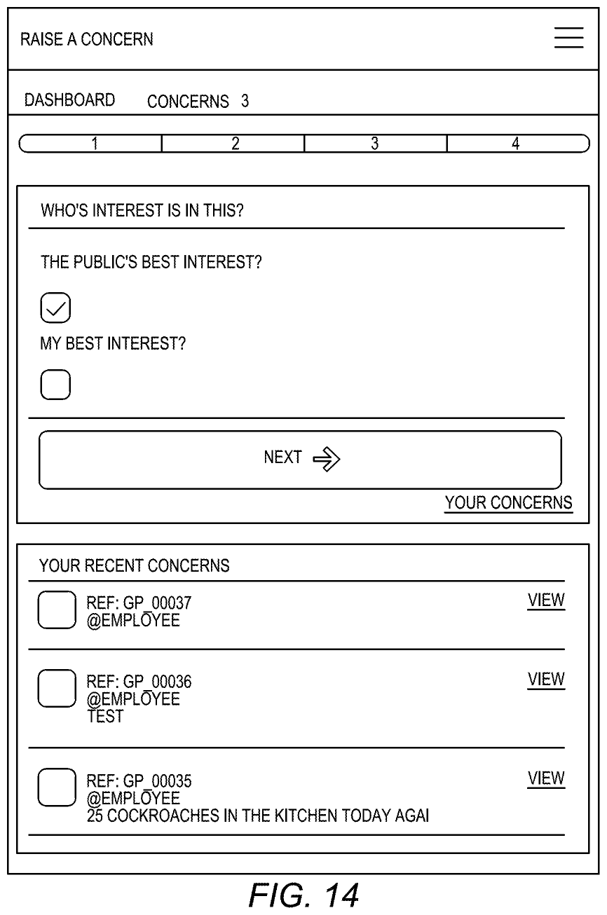

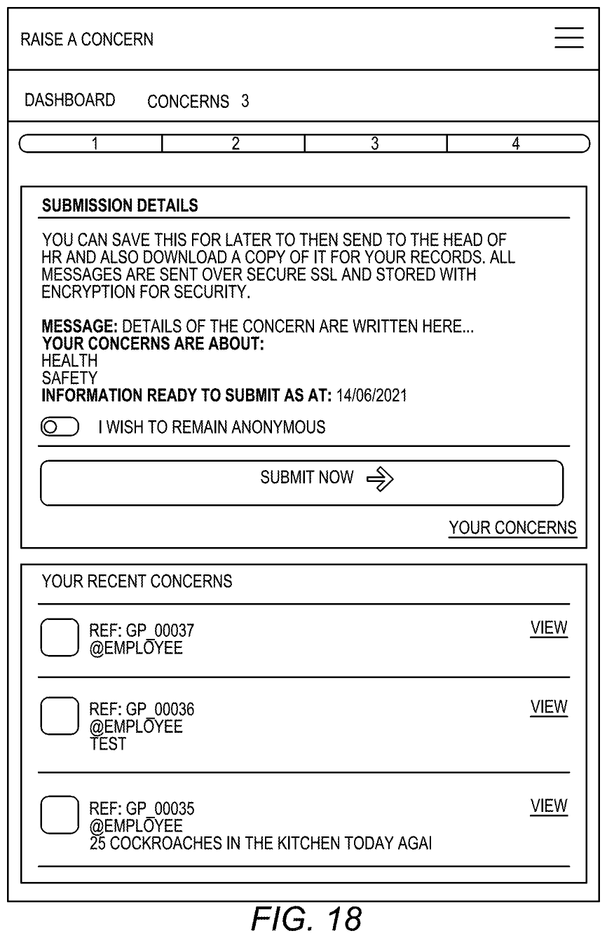

FIG. 9 through FIG. 25 are examples of user interface screens illustrating the progression through the flow diagrams of FIG. 5 through FIG. 8. The process generally begins with the employee login screen shown in FIG. 9. The system, in one example, generally allows the employee to submit a concern to their employer via phone app/web app. The message is then stored with encryption. The employer can respond to the concern within the employer admin area of the system.

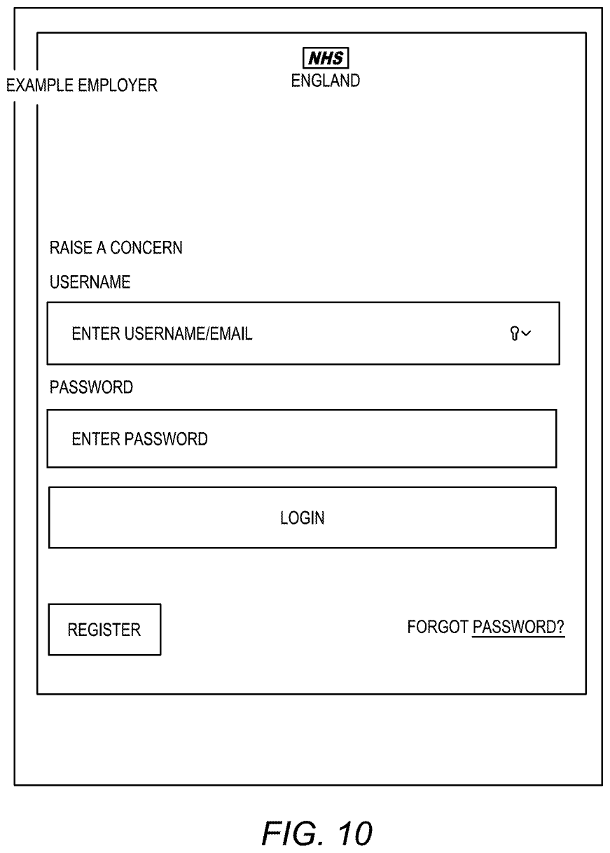

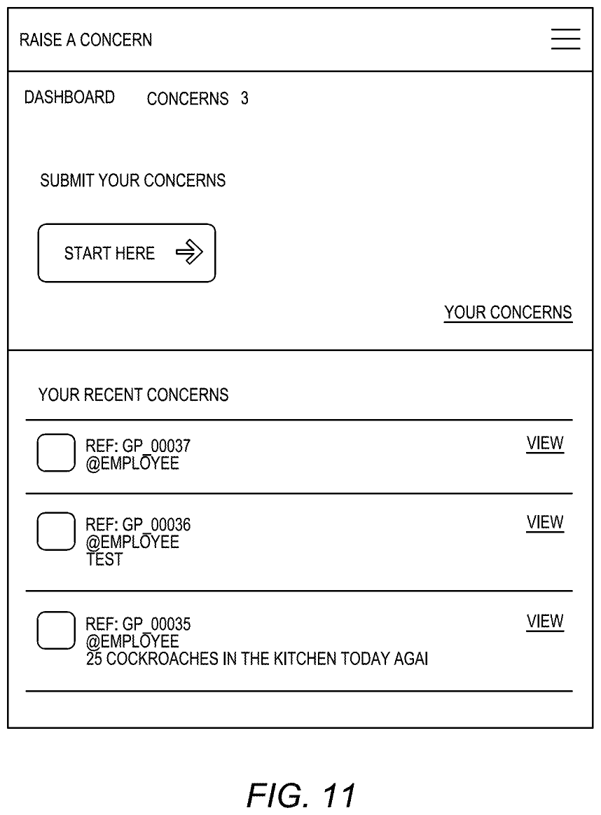

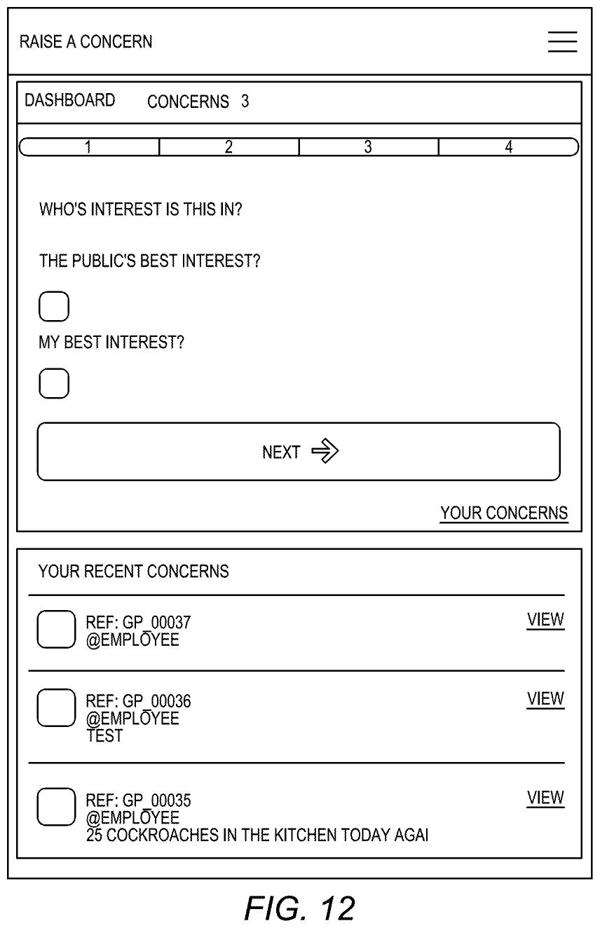

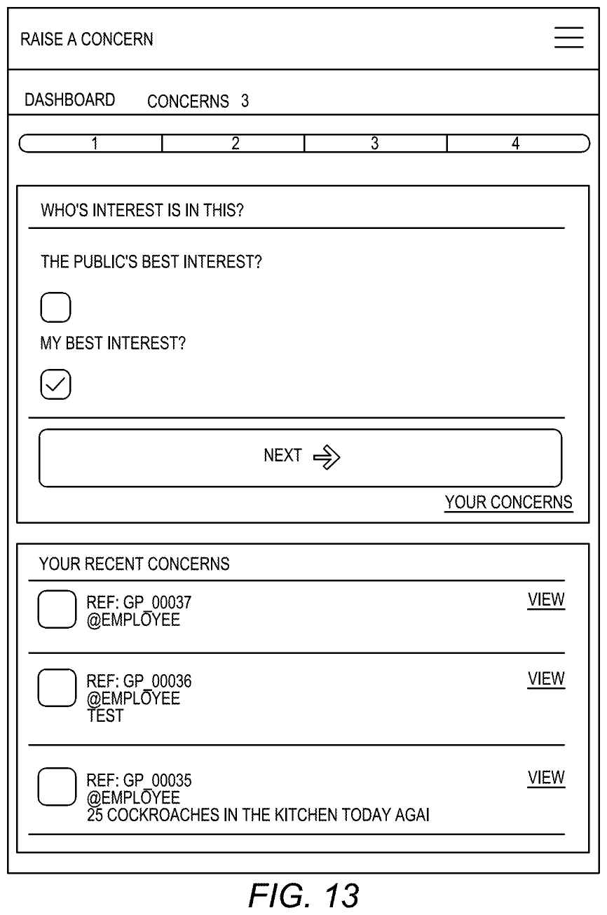

FIG. 10 is a general logon screen for an example employer NHS. The employee enters their username/email and password as shown. The process continues to FIG. 11. Previous concerns and a new concern can be submitted. In one example, the concerns are uploaded in different file formats or document formats or both. In another example, the concern is typed into the interface through typing of voice-to-text. The process continues to FIG. 12. The process status is shown in FIG. 12. The other “recent concerns” as also shown in this example. The process continues to FIG. 13.

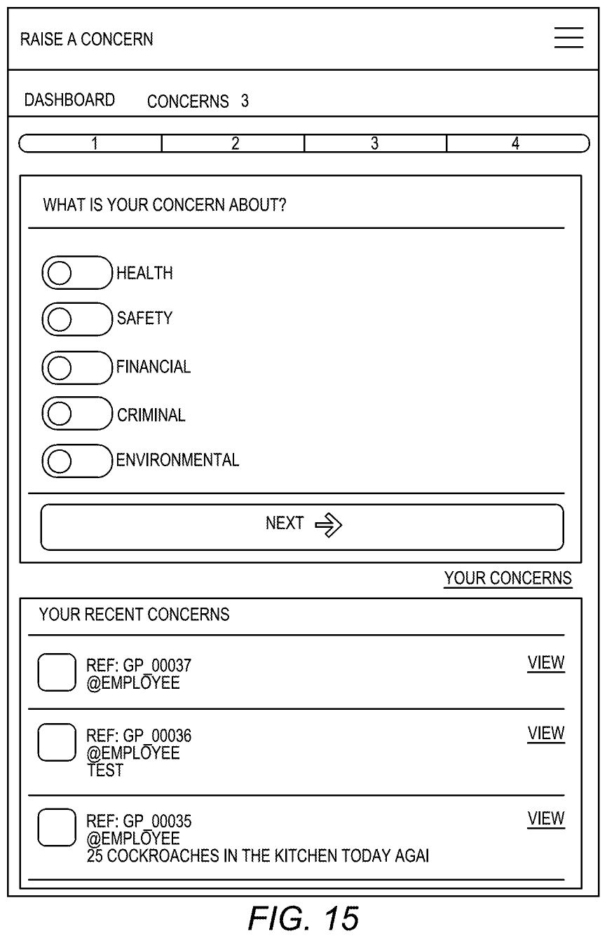

In FIG. 13, a qualifying question is asked the employee “Who's interest is this in?” In the even the logged-in employee answers that it “My best Interest” as discussed above the process ends. Otherwise, in the event the logged-in employee answers “The Public's best interest” the process continues to FIG. 15.

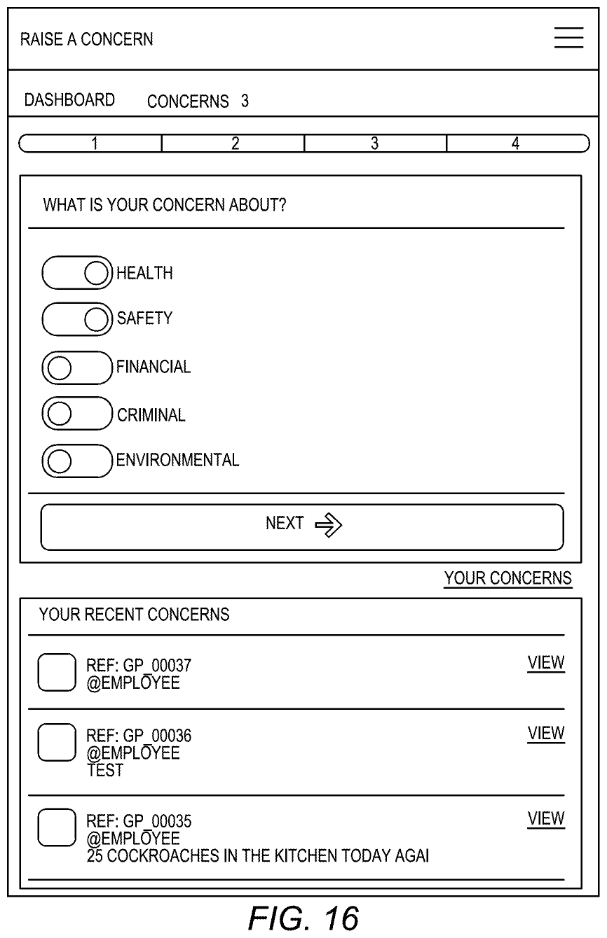

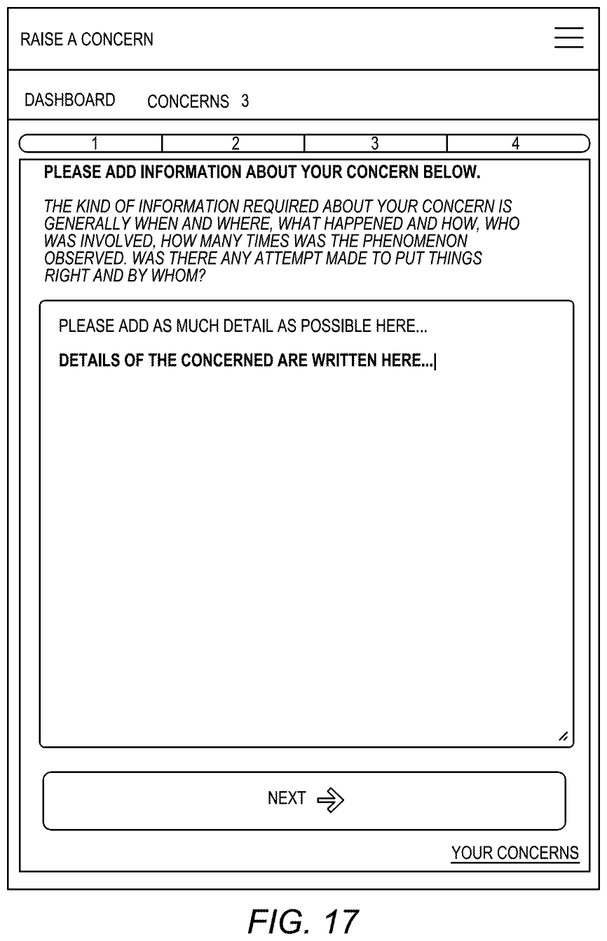

In FIG. 15, categories for the concern may be selected with toggle switches as shown. In this example, the toggle switches are “Health”, “Safety”, “Financial”, “Criminal” and “Environmental.” Selections are shown in FIG. 16 and the process continues to FIG. 17. The progress through the process is shown, in one example, by the top status bar with steps “1”, “2”, “3”, and “4” as shown.

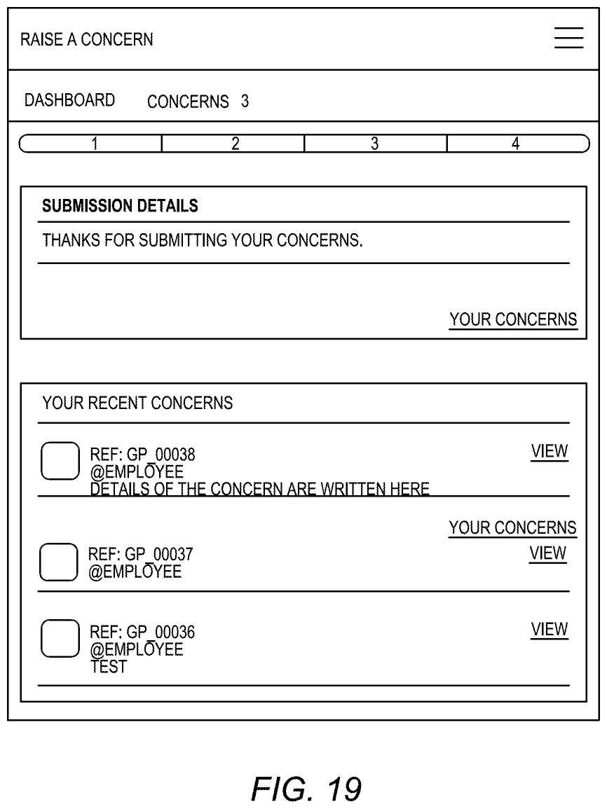

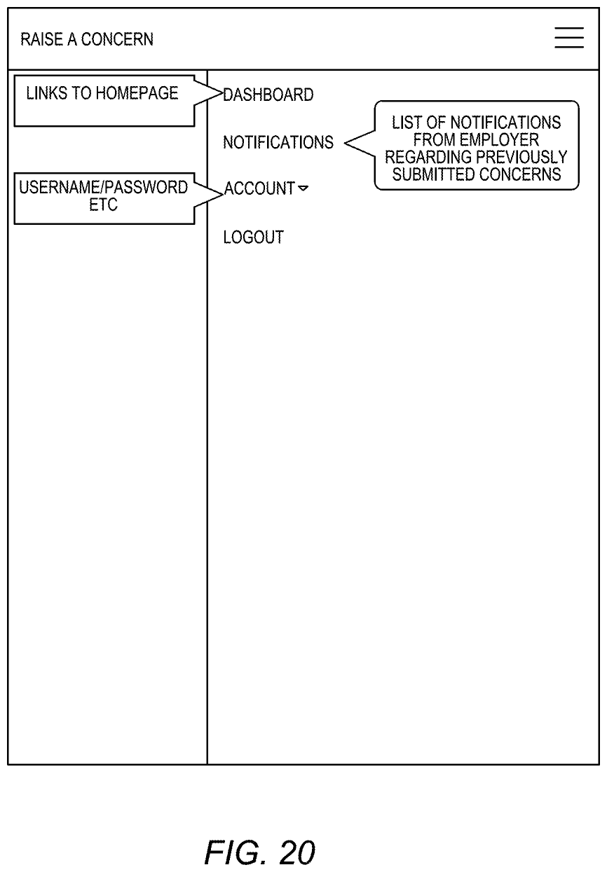

In FIG. 17, the signed-in employee is able to add their information about their concern in a free text box field by typing or using voice-to-text. In another example, the signed-in employee can upload documents in various file formats and/or document formats that are converted into a uniform format. Once the employee is satisfied with their description, the “submit now” button is selected. The system acknowledges the submission in FIG. 19 and the process continues to FIG. 20. In FIG. 20 the signed-in employee can navigate to various areas of the App or website as shown. For example, the “Notifications” may contain a list of notifications from the employer regarding previously submitted concerns from the employee.

In one example, the App will locally store on the mobile device all the of the information without having an Internet cellular or Wi-Fi connection. This allows the employee to begin the process even in settings such as factories, shop floors, theatres, schools, and other places in which public access to wireless communication is limited. In this example, when the signed-in user has re-established a wireless connection Internet connection, the process information previously cached on the employee's device is automatically sent to the server.

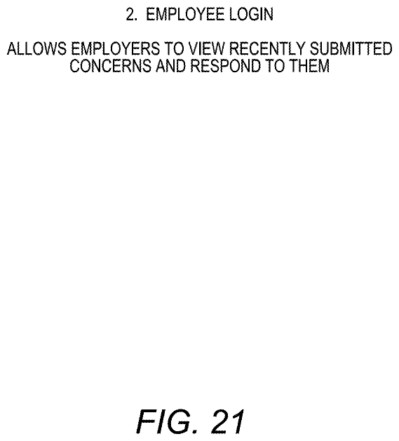

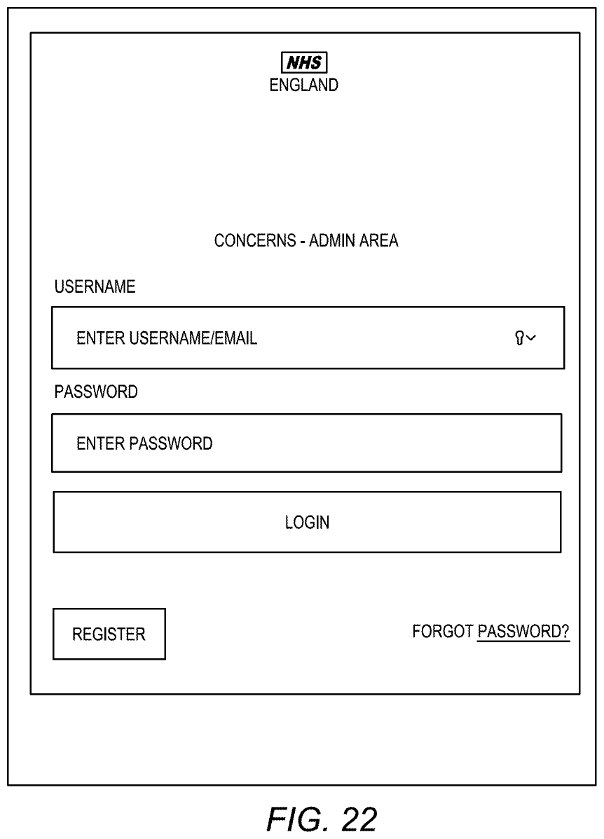

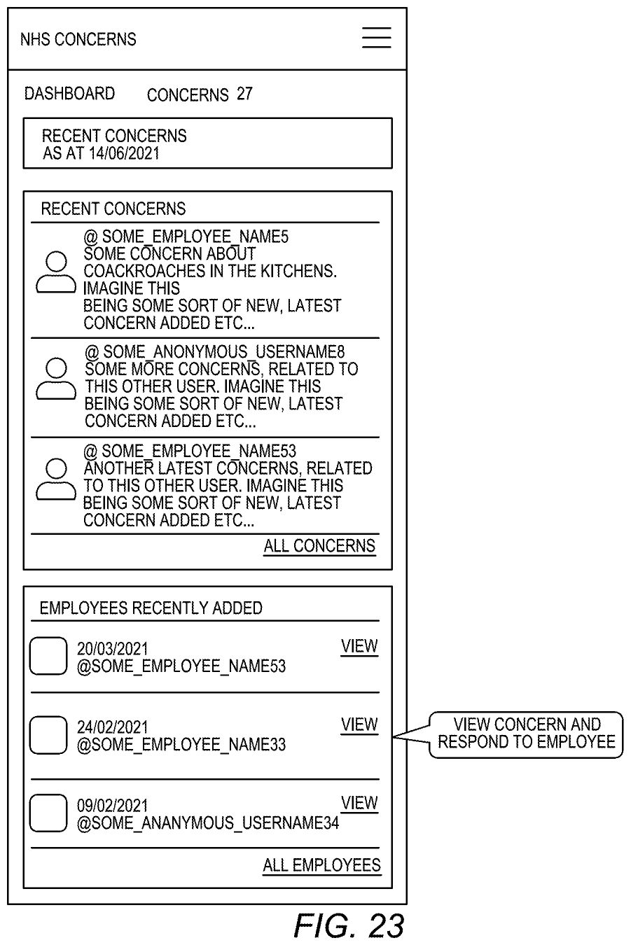

Turning to FIG. 21, shown are example screens of what the employer process entails. In FIG. 22, the employer, in this case, NHS, logons into the system using a username/email and password. The process continues to FIG. 23.

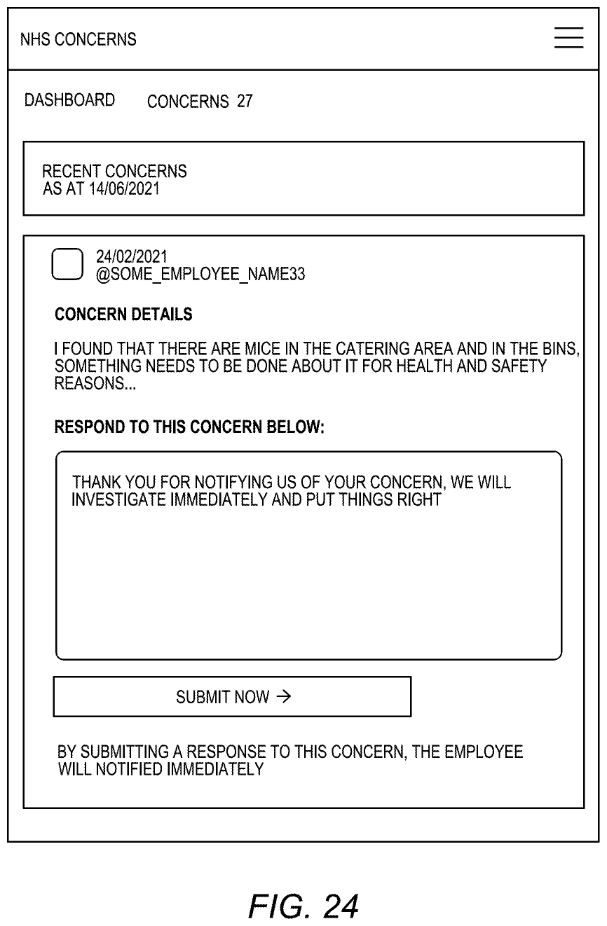

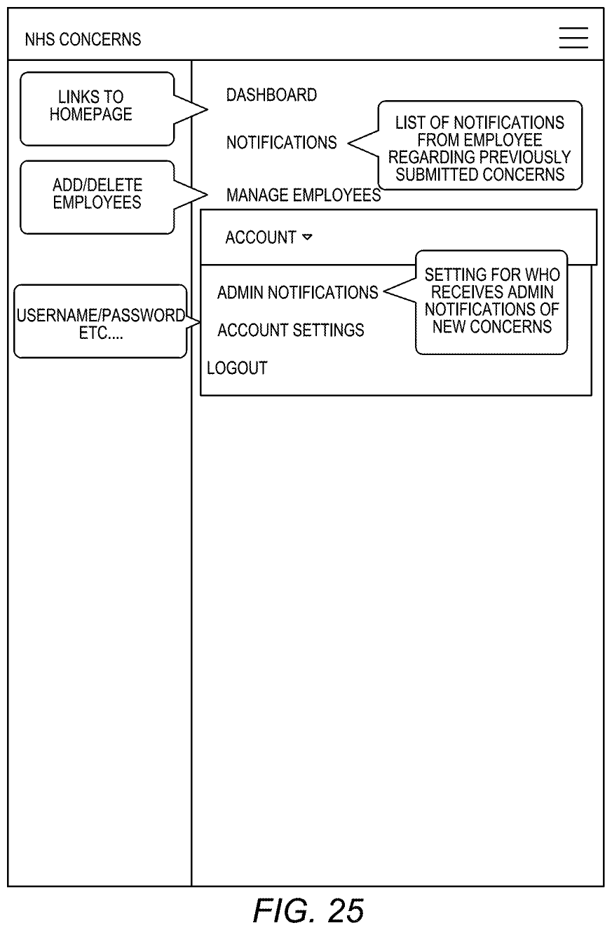

In FIG. 23, the employer can view “recent concerns” and items “Employees recently added.” In response to the employer selecting one of the concerns, the process continues to FIG. 24. The employer in FIG. 24, can respond to the concern as shown and select the “Submit button.” The process continues to FIG. 25 in which the employer can navigate to various areas of the App or website as shown.

### Non-Limiting Software Examples

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been discussed above with reference to flowchart illustrations and/or block diagrams of methods, apparatus (systems) and computer program products according to various embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The description of the present application has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

All references cited herein are expressly incorporated by reference in their entirety. It will be appreciated by persons skilled in the art that the present disclosure is not limited to what has been particularly shown and described herein above. In addition, unless mention was made above to the contrary, it should be noted that all of the accompanying drawings are not to scale. There are many different features to the present disclosure and it is contemplated that these features may be used together or separately. Thus, the disclosure should not be limited to any particular combination of features or to a particular application of the disclosure. Further, it should be understood that variations and modifications within the spirit and scope of the disclosure might occur to those skilled in the art to which the disclosure pertains. Accordingly, all expedient modifications readily attainable by one versed in the art from the disclosure set forth herein that are within the scope and spirit of the present disclosure are to be included as further embodiments of the present disclosure.

What is claimed is:

1. A method for determining a benefit for an insurance policy of an insured entity, the policy associated with a worker of the insured entity, the method comprising:
retrieving data indicative of: (i) a disclosure event characteristic of a disclosure made by a worker of the insured entity; (ii) an indication that the disclosure event is in a public interest; and (iii) a trigger event;
comparing the data indicative of the disclosure event and the data indicative of the trigger event;
determining, based at least in part on a result of the comparing, a link between the trigger event and the disclosure event;
determining that a predetermined time threshold has not been exceeded; determining, based on the data indicative of the disclosure event and the data indicative of the trigger event, a benefit for the insurance policy; and
transmitting an indication of the benefit for the insurance policy.

2. The method of claim 1, wherein the worker is one selected from: a part-time or full-time employee of the insured entity; a contractor of the insured entity; a self-employed affiliate of the insured entity; and a registered student of the insured entity.

3. The method of claim 1, wherein the disclosure event comprises data associated with the insured entity.

4. The method of claim 1, wherein the data indicative of the disclosure event comprises identification data linked to the worker.

5. The method of claim 4, wherein the identification data may be anonym ised by the worker but can be declared to the insured entity at a later stage.

6. The method of claim 1, wherein the trigger event is one selected from: a registered grievance received from the worker; a registered suspension of employment and/or contract and/or registration status of the worker; a registered maltreatment or discriminatory treatment recorded by the worker; a registered termination of employment, a registered termination of contract, or a registered termination of registration status of the worker.

7. The method of claim 1, wherein the data indicative of the trigger event comprises identification data linked to the worker.

8. The method of claim 7, wherein the identification data may be anonymised.

9. The method of claim 1, wherein the public is one selected from: the insured entity; a populous of a country or region, or a governing body of the country or region.

10. The method of claim 1, wherein the data indicative of an indication that the disclosure event is in the interest of a public as opposed to the best interest of the worker, is retrieved from an entity separate from the insured entity.

11. The method of claim 1, wherein the comparing and/or the determining based at least in part on a result of the comparing, a link between the trigger event and the disclosure event comprises:
identifying that the data indicative of the disclosure and the data indicative of the trigger event comprise identification data associated with the worker.

12. The method of claim 1, wherein the predetermined time threshold is a legal or regulatory time period, time limit if applicable or time threshold associated with an interval between raising a concern and the application of a detriment to the worker.

13. The method of claim 1, wherein the benefit comprises one or more selected from: a reinstatement of a contract of the worker; and compensatory relief for the worker; previous or future legal fees of the worker.

14. The method of claim 13, wherein the compensatory relief comprises one or more selected from: lost income of the worker associated with the trigger event; damages associated with the trigger event; legal expenses to remedy loss and award damages.

15. The method of claim 1, wherein the insurance policy comprises either an existing insurance policy or a potential insurance policy to be offered to the entity.

16. The method of claim 1, wherein the retrieving data further comprises:
retrieving data in one file format and converting the data to a second file format, the second file format being a standardized file format subsequently used for comparing the data.

17. The method of claim 1, wherein the retrieving data further comprises:
retrieving data in one document format and converting the data using natural language processing into categorized areas of interest subsequently used for comparing the data.

18. The method of claim 1, further comprising:
in response to a worker's mobile device being disconnected from a wireless data network, caching data on the worker's mobile device; and
in response to the worker's mobile device being connected to the wireless data network, automatically sending the data which has been cached to a computer operating to the method for determining the benefit.

19. A system for determining a benefit for an insurance policy of an insured entity, the policy associated with a worker of the insured entity, the system comprising:
a computer memory for storing data indicative of: (i) a disclosure event characteristic of a disclosure made by a worker of the insured entity; (ii) an indication that the disclosure event is in the interest of a public; and (iii) a trigger event; and
a processor in communication with the memory, wherein the processor is configured to:
determine the presence of an indication;
compare the data indicative of the disclosure event and the data indicative of the trigger event;
determine, based at least in part on a result of the comparing, a link between the trigger event and the disclosure event;
determine that a predetermined time threshold has not been exceeded;
determine, based on the data indicative of the disclosure event and the data indicative of the trigger event, a benefit for the insurance policy; and
transmit an indication of the benefit for the insurance policy.

20. A non-transitory, computer readable medium having stored thereon instructions that, upon execution, cause a computing device to perform the method of claim 1.
